(19) United States
(12) Patent Application Publication
(10) Pub. No.: US 2006/0048592 A1
(43) Pub. Date: Mar. 9, 2006

(54) Damping nut for screw-driven mechanism

(76) Inventor: Tom Thang Ung, Milpitas, CA (US)

Correspondence Address: MORGAN & FINNEGAN, L.L.P., 3 World Financial Center, New York, NY, 10281-2101, US

(21) Appl. No.: 10/938,456

(22) Filed: Sep. 9, 2004

(51) Int. Cl. F16H 25/20

(52) U.S. Cl. 74/89.23

(57) ABSTRACT

A vibration damper for screw-driven mechanical systems includes a nut body and one or more attached damping elements. The nut body includes internal threads for cooperating with a lead screw of a screw-driven mechanical system. The damping element may be a viscoelastic material or other material. The damping element may be arranged on an outer surface of the nut body, and may either be exposed or protected by another element. A tuning mass may be applied to the vibration damper by attachment to the damping element. In some embodiments, the damping element is arranged on a cantilever element of the nut body. In other embodiments, the damping element is segmented and is distributed such that air passages are formed between the damping element segments.

### BACKGROUND OF THE INVENTION

1. Field of the Invention

The present invention relates to the field of screw-driven machinery, more particularly to traveling nuts in such screw-driven machinery.

2. Description of Related Art

Precision lead screw and nut assemblies are used in positioning and locating applications, such as milling machines, automated metrology systems, factory automation systems, and wafer manufacturing equipment. Lead screw assemblies can also be used purely for the conversion of power or motion, such as jack lifts and elevator doors. Translating screws and nuts make very cost-effective solutions to motion applications. The disadvantage of lead screw assemblies is that they can develop unwanted noise and vibrations. Lead screw assemblies may experience longitudinal, torsional, and transverse oscillations during operation. There are many possible causes for these oscillations. Misalignments in the assembly and friction between the mating surfaces of the screw and nut threads typically may cause unwanted vibrations.

An attempt to reduce vibration by means of improving alignment is described in U.S. Pat. No. 6,099,166 to Erikson et al. (“Erikson”). In Erikson, a radial-stabilizing bushing that maintains contact with the outer diameter of the screw is incorporated in the nut. The bushing reduces radial fluctuations between the nut and screw when in motion, thereby reducing vibration. One of the drawbacks to this approach is the outer diameter of the screw must be precise. In addition, the bushing is subjected to wear.

Another method of reducing vibration is by preloading the nut threads against the screw threads in U.S. Pat. No. 6,535,305 to Chang et al. (“Chang”). Chang describes how a nut can be configured to reduce vibration. In Chang, nut halves are forced against screw threads by means of springs. A pre-load in the springs keep the internal thread of the nut in close contact with the external thread of the screw. However, the spring pre-load introduces a drag torque, and the assembly is still subjected to resonant frequencies.

There have also been attempts to reduce or eliminate vibrations by damping the screw directly. One such attempt is described in U.S. Pat. No. 5,379,660 to Ishikawa and U.S. Pat. No. 4,671,127 to Yamaguchi et al., in which a vibration damping mechanism is loosely fitted on a free end of the screw. The damping mechanism suppresses vibration by means of impact damping (or single particle impact damping). Tests have shown that mounting an impact damping mechanism at the end of the screw can address vibration issues, but there are limitations to that concept. Moreover, the overall length of the screw must be increased when an approach such as these is taken, and special machining and special assembly procedures are required.

### BRIEF SUMMARY OF THE INVENTION

One object of the invention is to provide a simpler and more compact means for damping vibrations within a screw-driven mechanism. Another object of the invention is to provide a means for damping vibrations within a screw-driven mechanism that is effective over a wide range of frequencies and multiple modes of vibration. Still another object is to provide a vibration damper for the above-described purpose that is easy to manufacture and assemble in a system. Yet another object of the invention is to provide a vibration damper for the above-described purpose having no wearing components.

The present invention relates to a nut for use in screw-driven machinery, and damping in conjunction therewith. The nut travels along a lead screw in a device, and includes a damping element thereon. Depending on the specific embodiment, the damping element may be passive, and further, may be a damping material, such as a viscoelastic material.

Depending on the embodiment, the damping element is placed in one or more predetermined locations on the nut. In a first embodiment, the damping element is a damping material that surrounds the outer circumference of the nut. In another embodiment the damping element is arranged on one or more ends of the nut.

In a variation of certain embodiments, a bearing layer, tuning mass or constraining layer is arranged on top of the damping material to distribute forces received by the nut to the damping element.

As a further variation, the damping element is arranged in separate segments on the damping nut, between the damping nut and the bearing layer. This may be implemented to achieve increased air circulation around the nut and/or the damping element. This also can vary, in conjunction with the specific type of damping element or damping material used, the magnitude of resistance of the damping element to movement.

In a further embodiment, a cantilever member is arranged on the nut body to flex in response to applied forces. Such cantilever member may protrude longitudinally from the nut body or radially from the nut body, depending on the embodiment. Similarly to the above, a damping element may additionally be incorporated with the nut having a cantilever member.

The damping element is, in a preferred embodiment, a viscoelastic material (VEM).

### BRIEF DESCRIPTION OF THE DRAWINGS

FIG. 1a is a cross-sectional side view of a first embodiment of the present invention;

FIG. 1b is an isometric view of the first embodiment of the present invention;

FIG. 2 is a cross-sectional side view of a second embodiment of the present invention;

FIG. 3a is a cross-sectional side view of a third embodiment of the present invention;

FIG. 3b is an isometric view of the third embodiment of the present invention;

FIG. 4 is a cross-sectional side view of a fourth embodiment of the present invention;

FIG. 5 is an isometric view of the fourth embodiment of the present invention;

FIG. 6 is a cross-sectional end view of a fifth embodiment of the present invention;

FIG. 7 is an isometric, partially cut-away view of a sixth embodiment of the present invention;

FIG. 8 is a cross-sectional side view of a seventh embodiment of the present invention;

FIG. 9 is a cross-sectional side view of a eighth embodiment of the present invention; and

FIG. 10 is a cross-sectional side view of a ninth embodiment of the present invention.

### DETAILED DESCRIPTION

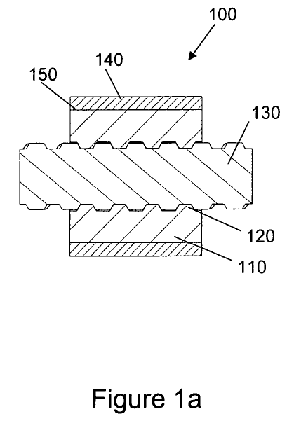

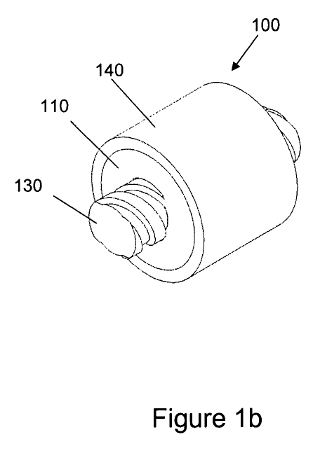

FIGS. 1a and 1b illustrate a first embodiment the vibration-damping nut, which comprises a nut body 110 with internal threads 120 engaged with the threads of a lead screw 130. A damping element, which may be a passive-damping element 140, is in contact with the nut body 110 at its outer surface 150. In a preferred embodiment, the damping element is a viscoelastic material (VEM) that transfers vibration-energy into thermal heat. In such embodiment, strain energy is transferred to the VEM through the surface 150 of the nut body 110. An adhesive can be used to attach the damping element 140 to the nut body surface 150, and a recess may alternatively or additionally be formed in the nut body 110 to hold the damping element.

In this and in other embodiments, the damping element is linked to a surface of the nut, which linking can be accomplished in a variety of manners, including friction fitting, by an adhesive, or other means. Contact between the damping element and the nut allows the transfer of vibration-energy to the damping element.

A preferred passive damping element is manufactured from a viscoelastic material (VEM). Viscoelastic materials damp vibrations by converting vibration-energy into thermal heat. Referring to FIGS. 1a and 1b, a VEM can be placed directly on the body of the nut with or without an adhesive or mechanical fastener. In use, vibration-energy that is transferred to the VEM will dissipate in the form of heat, thereby damping the vibration and eliminating noise that may occur in a machine, such as those having a rotary lead screw device. The vibration energy and the consequent strain experienced can be in any dimension. The strain may be realized in torsional, axial, or radial strain, or in a combination thereof.

FIGS. 1 through 10 illustrate various possible embodiments of a nut accommodating a damping element, which may be a VEM.

It is to be noted that in this and in all embodiments, the term “nut” refers both to what is conventionally thought of in the field of mechanical systems, and also to any component that travels along a lead screw in a mechanical system. Typically these components are roughly cylindrical, and since they ride on threads of a screw, the term nut is generally used. It is to be understood, however, that the invention is not limited only to use with a “nut.”

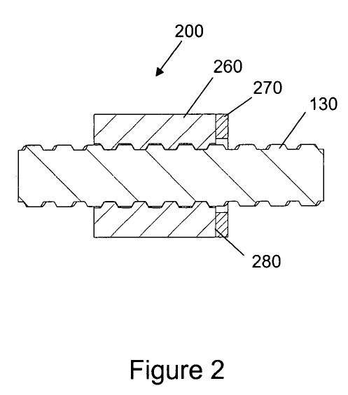

FIG. 2 illustrates a second embodiment of a nut having a ring-shaped damping element 270 positioned such that it is in contact with the nut 260 at a radial surface 280, which is radial relative to a central axis of the nut body. This axis, of course, is essentially collinear with a central axis of the lead screw 130. In this specific embodiment, the radial surface 280 is at the end of the nut body 260, but need not be, but depends on the specific embodiment.

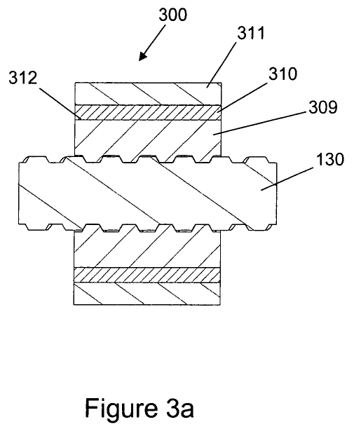

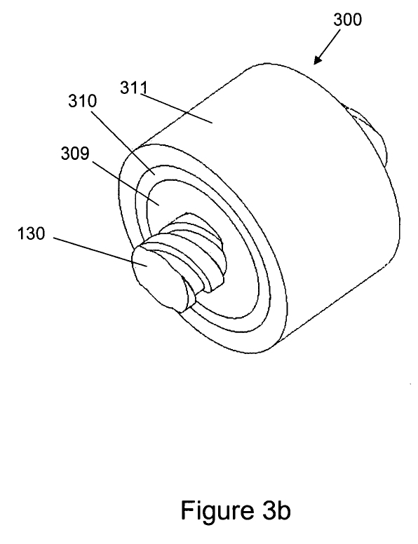

FIGS. 3a and 3b illustrate a third embodiment of the present invention. In this, as well as in other selected embodiments, a mass 311 is in contact with a damping element 310. In this embodiment, the mass 311 is substantially tubular with a substantially circular cross section, though other cross-sections are very much possible in this and in other embodiments.

The mass 311 acts as a constraining layer to assist in creating strain in the damping element 310. This is accomplished because the mass 311 helps distribute loads evenly to the damping element 310, due to its rigidity. The mass 311 also acts as a tuning mass to assist in damping vibration. The magnitude of the mass (weight) of mass 311 is pre-selected for a desired behavior under anticipated loading conditions of the nut 300. By pre-selecting the mass (weight) of the mass 311, the natural frequencies (rotational and linear) can be adjusted, as can the natural frequencies of the entire system attached thereto. As such, undesired resonance can be avoided. Energy from the nut body 309 is transferred to the damping element 310 through surface 312 of the nut body 309, and the energy is dissipated. Mass 311 also assists in protecting the damping element 310 from the environment.

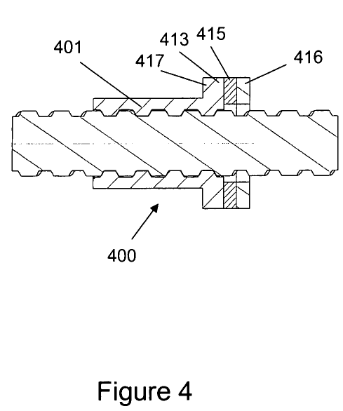

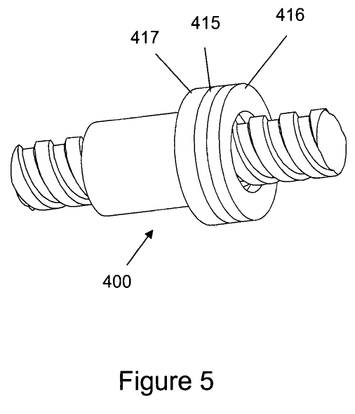

FIGS. 4 and 5 illustrate nut 400. A damping element 415 is in contact with surface 413 of a flange 417 on the nut body 401, and is constrained axially by a tuning mass 416. Mass 416 also assists in protecting the damping element 415 from the environment. The structure of nut 400 is similar to the structure of nut 300 in FIG. 3. However, this embodiment includes the tuning mass 416 at the end of the nut body, rather than around its circumference. As with nut 300, the tuning mass can be used to accomplish various goals, as set forth above.

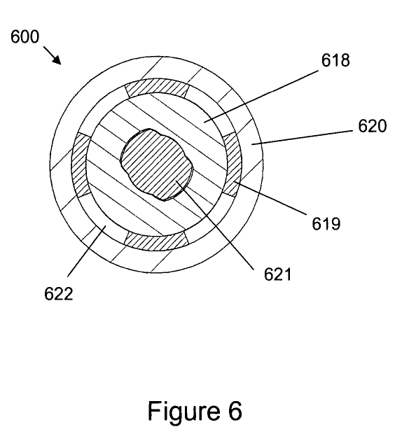

FIG. 6 illustrates a nut 600, representing a fifth embodiment of the invention. Nut 600 is variant of the nut 300 illustrated in FIG. 3. A nut body 618 is mounted onto a screw 621. Damping element segments 619, are in contact with the nut body 618 and with a tuning mass 620. Each damping element segment 619 is separated by a gap 622 to assist heat dissipation. The damping element segments 619 are constrained between the nut body 618 and a rigid mass 620, which is in the form of a tubular sleeve. The damping element performance is improved in a constrained state, as compared with an unconstrained state, for example, as shown in FIG. 1, because the loads can be distributed across essentially all of the viscoelastic material. In addition, segmenting the damping elements 619 improves manufacturability and eases assembly over using a solid damping element.

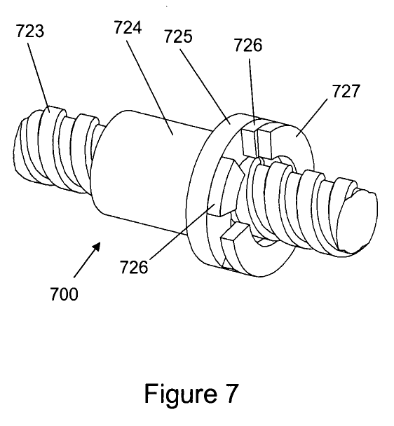

FIG. 7 illustrates a nut 700, representing a sixth embodiment of the present invention. A nut body 724 is mounted on a screw 723, and has a flange 725 that is in contact with damping element segments 726. The damping element segments 726 are separated by a gap. A tuning mass 727 constrains the damping elements 276 axially. Unlike the embodiment of nut 400 shown in FIG. 4, which uses a solid ring-shaped damping element 415, this configuration utilizes damping element segments 726. Such segments 726, and the resultant gaps therebetween, promote airflow around and cooling of the damping segments 726, as well as other components.

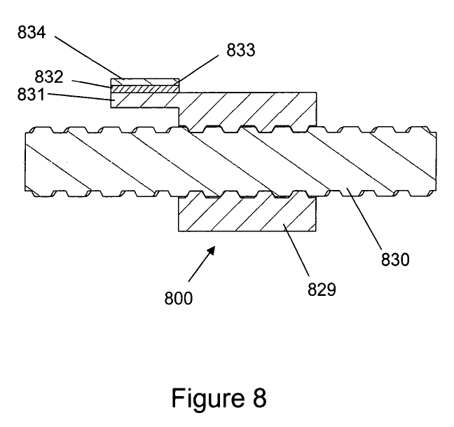

FIG. 8 illustrates a nut 800, representing a seventh embodiment of the present invention. A nut body 829, mounted to a screw 830, has a cantilever member 831 extending from one end. The cantilever member 831 is thinner in cross-section than the nut body 829. When vibrated, the cantilever member 831 flexes, transferring vibrational energy to a damping element 832, via surface 833. A tuning mass 834 constrains the damping element 832 such that it experiences shear strains substantially uniformly across its whole surface.

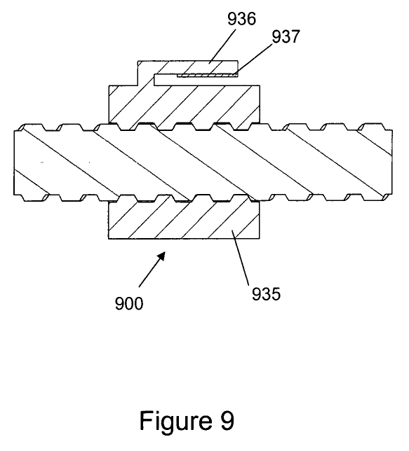

FIG. 9 illustrates nut 900, which is an alternate embodiment to nut 800 shown in FIG. 8. Nut 900 has a nut body 935 and an arm 936 that extends out of the body of the nut body 935. The arm functions as a flexing member to transmit vibrational energy to a damping element 937.

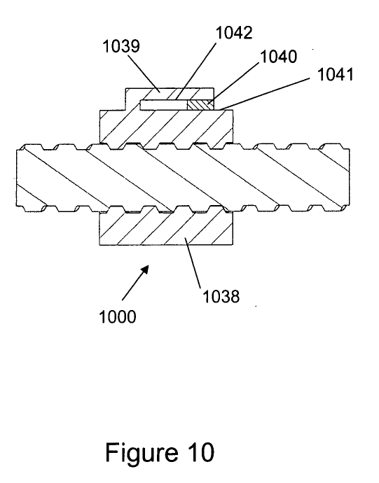

FIG. 10 illustrates nut 1000, which is a variant of nut 900 shown in FIG. 9. A nut body 1038 has a flexure member 1039 that is in contact with a damping element 1040, which in-turn, is also in contact with the nut body 1038. The surface 1041 of the nut body 1038 helps to constrain the damping element 1040. Vibrational energy is transmitted from the flexure member 1039 through surface 1042 to the damping element 1040. With the damping element 1040 positioned between surface 1041 and 1042, the damping element 1040 is also shielded from the environment, and thus also from damage.

While the embodiments of FIGS. 8-10 only show one portion of the nut as a cantilever, it is to be understood, that depending on the embodiment, there may be multiple cantilevers. Alternatively, such cantilever may be circumferential and surround all or a segment of its respective nut body.

As one alternative to the use of viscoelastic material as the damping element, it is possible to utilize impact damping in accordance with the invention to achieve a desired result.

As another alternative to the use of viscoelastic material as the damping element, it is possible to utilize friction damping in accordance with the invention to achieve a desired result.

It is to be understood that though not specifically set forth herein, other embodiments are possible while still keeping with the spirit of the invention.

1. A nut for translation along a rotatable screw, the damping nut comprising:
a nut body with internal threads that are complementary to the threads of the screw; and
at least one passive vibration-damping element affixed to the nut body, the nut having at least one surface for receiving and transferring vibratory surface strain to the vibration damping element.

2. The nut of claim 1, further comprising
a constraining rigid mass not in contact with the nut body, but in contact with at least one surface of the damping element, the constraining rigid mass assisting in distributing external forces to the damping element, and aiding in creating strain within the damping element.

3. The nut of claim 1, further comprising:
at least one longitudinal flexure member on the nut body, the longitudinal flexure member having at least one surface for transferring vibratory surface strain to the vibration damping element.

4. The nut of claim 1, further comprising:
at least one longitudinal flexure member on the nut body, the longitudinal flexure member having at least one surface for transferring vibratory surface strain to the vibration damping element; and
a constraining rigid mass not in contact with the nut body is in contact with the vibration damping element, the constraining rigid mass assisting in distributing external forces to the damping element, and aiding in creating strain within the damping element.

5. A nut for a screw-driven mechanism, comprising:
a nut body; and
a damping portion attached to the nut body to absorb vibration-related motion between the nut and a load.

7. A nut for a screw-driven mechanism, comprising:
a nut body having internal threads for mating with a screw of the screw-driven mechanism; and
a damping material arranged in a layer on an outer surface of the nut body to absorb vibration-related motion between the nut and a load.

8. The nut for a screw-driven mechanism of claim 7, wherein the outer surface of the nut body includes a recess for receiving the damping material.

9. The nut for a screw-driven mechanism of claim 7, further comprising:
a load bearing plate arranged on an outer surface of the damping material to distribute a load experienced by the nut through the damping material, the load bearing plate also aiding in protecting the damping material from abrasion.

10. The nut for a screw-driven mechanism of claim 7, further comprising:
a tuning mass arranged on an outer surface of the damping material for adjusting a natural frequency of the nut, the mass of the tuning mass being pre-selected to alter the natural frequency of the nut to prevent unwanted resonance from occurring.

11. The nut for a screw-driven mechanism of claim 7, wherein:
the nut body is substantially cylindrical; and
the damping material is arranged in a layer about the circumference of the nut body.

12. The nut for a screw-driven mechanism of claim 7, wherein:
the nut body is substantially cylindrical; and
the damping material is arranged in a layer on one or more end surfaces of the nut body, the damping material being substantially annular in shape.

13. The nut for a screw-driven mechanism of claim 7, wherein:
the nut body has at least one substantially annular increased diameter end portion; and
the damping material is arranged on a face of the increased diameter end portion.

14. A nut for a screw-driven mechanism, comprising:
a nut body having internal threads for mating with a screw of the screw-driven mechanism;
a damping material arranged in a layer on an outer surface of the nut body to absorb vibration-related motion between the nut and a load; and
a load bearing plate arranged on an outer surface of the damping material to distribute a load, experienced by the nut, through the damping material, the load bearing plate also aiding in protecting the damping material from abrasion.

15. The nut for a screw-driven mechanism of claim 14, wherein the load bearing plate is a tuning mass for adjusting a natural frequency of the nut, the magnitude of mass of the tuning mass being pre-selected to alter the natural frequency of the nut in order to prevent unwanted resonance from occurring.

16. The nut for a screw-driven mechanism of claim 14, wherein:
the nut body is substantially cylindrical;
the damping material is arranged in a layer about a circumference of the nut body; and
the load bearing plate is substantially tubular in shape having a substantially circular cross-section, the inner surface of the load bearing plate contacting the outer surface of the damping material.

17. The nut for a screw-driven mechanism of claim 14, wherein:
the nut body is substantially cylindrical;
the damping material is arranged in a layer on one or more end surfaces of the nut body, the damping material being substantially annular in shape; and
the load bearing plate is substantially annular in shape, arranged on and contacting the damping material.

18. The nut for a screw-driven mechanism of claim 14, wherein:
the nut body has at least one substantially annular increased diameter end portion;
the damping material is arranged on a face on the increased diameter end portion,
the damping material being substantially annular in shape; and
the load bearing plate is substantially annular in shape, and is arranged on and contacts the damping material.

19. A nut for a screw-driven mechanism, comprising:
a nut body having internal threads for mating with a screw of the screw-driven mechanism;
a damping material arranged in segments at regular intervals on an outer surface of the nut body to absorb vibration-related motion between the nut and a load; and
a load bearing plate arranged on an outer surface of the damping material to distribute a load, experienced by the nut, through the damping material, the load bearing plate also aiding in protecting the damping material from abrasion.

20. The nut for a screw-driven mechanism of claim 19, wherein the load bearing plate is a tuning mass for adjusting a natural frequency of the nut, the magnitude of mass of the tuning mass being pre-selected to alter the natural frequency of the nut in order to prevent unwanted resonance from occurring.

21. The nut for a screw-driven mechanism of claim 19, wherein:
the nut body is substantially cylindrical;
the damping material segments are arranged at regular intervals about a circumference of the nut body; and
the load bearing plate is substantially tubular in shape having a substantially circular cross-section, the inner surface of the load bearing plate contacting the outer surface of the damping material, distributing loads across the damping material segments.

22. The nut for a screw-driven mechanism of claim 19, wherein:
the nut body is substantially cylindrical;
the damping material segments are arranged at regular intervals on one or more end surfaces of the nut body, the damping material being substantially annular in shape; and
the load bearing plate is substantially annular in shape, arranged on and contacting the damping material, distributing loads across the damping material segments.

23. The nut for a screw-driven mechanism of claim 19, wherein:
the nut body has at least one substantially annular increased diameter end portion;
the damping material segments are arranged at regular intervals on a face on the increased diameter end portion, the damping material being substantially annular in shape; and
the load bearing plate is substantially annular in shape, and is arranged on and contacts the damping material, distributing loads across the damping material segments.

24. A nut for a screw-driven mechanism, comprising:
a nut body having internal threads for mating with a screw of the screw-driven mechanism;
a cantilever member protruding from the nut body for receiving an external force, the cantilever bending in response to the external force, the cantilever aiding in isolating external vibration from the nut body; and
a damping element arranged in a layer on a surface of the cantilever to absorb vibration-related motion between the nut and a load.

25. The nut for a screw-driven mechanism of claim 24, further comprising:
a load bearing plate arranged on a surface of the damping element to distribute a load through the damping element, the load bearing plate also aiding in protecting the damping element from abrasion.

26. The nut for a screw-driven mechanism of claim 24, wherein the cantilever protrudes in a substantially axial direction, relative to a central axis of a lead screw.

27. The nut for a screw-driven mechanism of claim 24, wherein the damping element is arranged on an outer surface of the cantilever member, relative to a central axis of the nut body.

28. The nut for a screw-driven mechanism of claim 24, wherein the damping element is arranged on an inner surface of the cantilever member, relative to a central axis of the nut body, contacting the cantilever member.

29. The nut for a screw-driven mechanism of claim 24, wherein the damping element is arranged on an inner surface of the cantilever member, relative to a central axis of the nut body, contacting an inner surface of the cantilever member and an outer surface of the nut body.

30. The nut for a screw-driven mechanism of claim 24, wherein the damping element is a damping material.

31. The nut for a screw-driven mechanism of claim 24, wherein the damping element is a viscoelastic material.

32. The nut for a screw-driven mechanism of claim 24, wherein the damping element is a passive damping element.

33. A method for providing damping within a mechanical system, the method comprising:
providing a nut body having internal threads for mating with a screw of the screw-driven mechanism; and
arranging a damping material in a layer on an outer surface of the nut body to absorb vibration-related motion between the nut and a load.

34. A nut for a screw-driven mechanism, comprising:
a nut body having means for mating with a screw-driven mechanism; and
means for damping vibration-related motion between the nut and a load.
